(19) United States
(12) Patent Application Publication
(10) Pub. No.: US 2004/0081733 A1
(43) Pub. Date: Apr. 29, 2004

(54) Process for extruding ice cream, apparatus for achieving such extrusion and products resulting therefrom

(75) Inventors: Rene Joachim Buter, Vlaardingen (NL); Jonkheer Theodoor Poll, van de, Vlaardingen (NL); Rene Franciscus Remmerswaal, Gloucester (GB)

Correspondence Address: UNILEVER, PATENT DEPARTMENT, 45 RIVER ROAD, EDGEWATER, NJ, 07020, US

(73) Assignee: Good Humor - Breyers Ice Cream

(21) Appl. No.: 10/691,919

(22) Filed: Oct. 23, 2003

Related U.S. Application Data
(63) Continuation of application No. 09/833,987, filed on Apr. 12, 2001, now abandoned.

(30) Foreign Application Priority Data
Apr. 14, 2000 (EP) 00303174.7

(51) Int. Cl. A01J 1/00

(52) U.S. Cl. 426/516

(57) ABSTRACT

The present invention relates to a process for extruding ice cream, said process comprising delivering a plurality of ice cream flows to a nozzle characterised in that, one or more of said ice cream flows are divided into a plurality of additional flows within said nozzle before extrusion of said flows. The invention furthermore relates to an apparatus and novel ice cream products.

### TECHNICAL FIELD OF THE INVENTION

The invention relates to a process for extruding ice cream. More particularly the invention relates to a process for the division and extrusion of ice cream flows from a nozzle and moreover where said process is performed at point of sale. The invention further relates to apparatus for achieving such division and extrusion of ice cream flows and to products comprising at least two different ice cream compositions geometrically arrange into novel combinations.

### BACKGROUND TO THE INVENTION

Extrusion systems have been developed for extruding a multitude of food types such as bakery products, spreads and ice creams.

Products comprising a single ice cream composition are common on the market, a fact that has motivated manufacturers to generate distinctions on the basis of novel and interesting shapes. This can be seen in U.S. Pat. No. 5,415,534, wherein an extrusion nozzle is described comprising a lower mobile component having a slot extrusion die that rotates when in use, thus being capable of twisting an ice cream flow to generate a layered appearance in the final product. Such a extrusion system while advantageously being suitable for freshly extruding ice cream for the consumer at the point of sale, does not provide for combining a plurality ice cream compositions into a single product.

U.S. Pat. No. 5,135,767 describes a more complex extrusion system which tries to address the need for a product comprising a combination of different extrudable materials which are arranged in layers. In this instance ice cream and chocolate are sequentially vertically extruded, as superimposed spiralling layers, into a receptacle positioned therebelow. This system however, relies on a level of complexity that is highly disadvantageous. Not only are separate nozzles required for each extrusion material but the process further suffers from reliance on the coordination of horizontal rotational speed and altitude variation of the chosen receptacle, in combination with accurately controlling extrusion flow rates. Unsurprisingly this process allows only a slow unit production rate and clearly a more simple means of combining extrudable materials that could additionally efficiently be applied on an industrial scale would be desirable.

The prior art discussed herein further illustrates a need to create a product that achieves a layered appearance without the need for any rotating components or movement of the extrusion equipment. The use of mobile or rotating components suffers the considerable disadvantage of requiring regular maintenance and repair. In food extrusion such moving parts also raise serious issues of compromised hygiene as they have a tendency to make thorough cleaning more difficult.

The desire to combine different ice creams in a single product, wherein the distribution thereof is controlled, has been addressed in part by the prior art see Miss soft 253/p machine manufactured by Carpigiani. Nozzles have been configured with a plurality of inlet ports which maintain a plurality of distinct adjacent flows within the nozzle until the point of extrusion. Similarly nozzles have been configured wherein two ice cream flows may be combined within the nozzle, thus extruding as a single combined flow. In the following description a combined ice cream flow is defined as an ice cream flow comprising a plurality of parallel adjacent ice cream flows, wherein said adjacent ice cream flows differ in their composition. U.S. Pat. No. 5,718,926 provides an example of extruding as a single combined flow, wherein an outer flow is merged into a central flow, yielding a composite product which in cross-section shows the flow distribution pattern as predetermined by the internal nozzle dimensions.

Despite a high degree of activity in changing nozzle design, little further advance has been made to the development of novel product appearances through combined extrusion of differing ice cream compositions. In this respect the Applicant has recognised a need to maximise the degree of product variation that is achievable from a minimal number of inlet flows into a nozzle. In addressing this need the Applicant has identified a further need for achieving the division of one or more ice cream flows within a nozzle in a way that will allow the redistribution thereof, thus providing novel and desirably attractive product appearances when said ice cream flows are recombined.

It would be particularly desirable to develop such an extrusion technique that could be performed at the point of sale, thus allowing the consumer to benefit from not only the appearance advantages but also from freshly extruded ice cream. Moreover there are considerable benefits to be gained, whether for preparation at point of sale or in a factory environment, from the development of an extrusion technique that utilises a series of nozzles that are easily interchangeable, facilitating momentary alterations in extrusion pattern and consequently product appearance. Moreover particular advantage would be gained from having a series of such interchangeable nozzles that could be fitted to existing equipment.

The present invention seeks to address the problem of re-distributing one or more of a plurality of ice cream flows after their entry into an extrusion nozzle to subsequently allow the extrusion from said nozzle of novel flow arrangements. In addressing this problem the Applicant has advantageously also overcome the further limitations that have been herein identified with existing ice cream extrusion technology.

### BRIEF DESCRIPTIONS OF THE INVENTION

It is a first object of the present invention to provide process for extruding ice cream, said process comprising delivering a plurality of ice cream flows to a nozzle characterised in that, one or more of said ice cream flows are divided into a plurality of additional flows within said nozzle before extrusion of said flows.

By having incoming flows to a nozzle split within said nozzle it is possible to combine the resulting flows in a variety of geometrical arrangements for the production of ice creams that were previously unachievable.

A nozzle may be generally defined as any tube attached to the outlet of a pipe or pressure chamber which is capable of efficiently converting the pressure of a fluid into velocity.

Ice cream compositions are preferably delivered as separate flows to each of a plurality of entry ports. Such separate flows can be obtained from different ice cream compositions flowing parallel and adjacent to each other, such as can be seen in the Miss soft 253/p machine manufactured by Carpigiani. Said flows may be separated into flows of distinct composition, prior to passing into one of said entry ports by the insertion one or more planes into the path and parallel with the direction of the ice cream flow, said plane(s) being capable of dividing the flow at the interface(s) of the different compositions. It is surprising that adjacent flows can be efficiently and accurately separated in this way with minimal crossover of the differing ice cream compositions.

The recognition that combined flows can be suitably separated in this way renders the process of the invention highly amenable to configuration with existing standard ice cream equipment being capable of extruding a combined ice cream flow. Current manufacturers of such standard equipment include Carpigiani™.

In a preferred embodiment, the invention comprises a process as described, wherein prior to delivering the plurality of separate ice cream flows to the nozzle, a plurality of separate ice cream flows of one or more compositions and moving in a single flow direction, are combined into a single flow having one or more flow interfaces between said one or more compositions, wherein said combined flow is subsequently divided at said one or more flow interfaces to deliver the plurality of ice cream flows to the nozzle.

It is preferred that two flows of differing ice cream composition are delivered through two entry ports to the interior of the nozzle. Therein one or both of said flows divide at one or more positions to form a plurality of additional flows. Preferably both of the ice cream flows will divide into a plurality of additional flows within the nozzle. Re-convergence of the ice cream flows may subsequently occur at any point prior to extrusion from the nozzle, however it is preferred that at least some, and most preferably all, of the plurality of additional flows are extruded from the nozzle through distinct exit ports as this has been found to improve definition in the appearance of the extrusion product achieved.

It is also preferred that when exiting the nozzle the combined flow is extruded downwards in a substantially vertical orientation as this facilitates the symmetrical shaping of the extrusion product.

The configuration by which the ice cream flows divide within the nozzle is determined by the internal geometry of said nozzle. The applicants have found that this is most effectively achieved by providing an internal geometry that remains fixed. A fixed internal geometry has been seen to provide repeatable results and moreover, does not suffer from the maintenance and hygiene problems associated with the moving parts of nozzles with variable internal geometry's. Therefore in a preferred embodiment the present invention comprises a process for extruding ice cream as described above wherein the nozzle has a fixed internal geometry.

The flow of ice cream through the nozzle can be controlled through the operation of a valve upstream of the nozzle, wherein said valve is preferably positioned as close to the entry ports of the nozzle as possible. The relaxation of ice cream and its consequent expansion on exposure to atmospheric pressure within the nozzle causes the ice cream flows to expand beyond the exit ports between dispensing and, depending on the period of nonuse, this may melt. Where expansion occurs the ice cream content within the conduits will vary and give an uneven start position for extruding the next portion. Positioning the valve as close to the entry ports as possible minimises this effect by reducing the volume of ice cream held within the nozzle between dispensing and therefore reducing the expansion possible.

A further embodiment of the invention therefore comprises a process for extruding ice cream as described above, wherein the delivery of ice cream flows to a plurality of entry ports in said nozzle is controlled by a valve immediately upstream of the nozzle.

While ice cream may be delivered to the nozzles of the invention from any sources of extrudable ice cream it is preferred that ice cream is delivered from either cold extrusion equipment or more preferably a plurality of ice cream holding means. It is one preferred embodiment of the invention that comprises a process for extruding ice cream as described, wherein the ice cream flows delivered to the entry ports of the nozzle flow from a plurality of holding means.

It is a second object of the present invention to provide a method of dispensing fresh ice cream at point of sale comprising the steps;

(i) opening a valve to deliver a plurality of ice cream flows to a nozzle;

(ii) filling a containing means with ice cream flowing from the nozzle;

(iii) closing the valve on completion of the filling;

characterised in that, subsequent to step (i) one or more of the ice cream flows are divided into a plurality of additional flows within the nozzle before extrusion.

Preferably the containing means in step (ii) is an edible cone. This aspect allows the consumer to fully benefit from the novel appearances of products achieved by the process of the invention in extruded ice cream, prepared at point of sale.

In a preferred embodiment of the invention, the nozzle is chosen from a plurality of different interchangeable nozzles from which a selection may be made on the basis of the geometrical combination of ice cream composition and product shape sought by the consumer.

It is a third object of the present invention to provide apparatus for extruding a plurality of ice cream flows in a single flow direction, comprising a nozzle, said nozzle comprising a plurality of entry ports, wherein each entry port is connected to an exit port by way of a conduit running through the nozzle, characterised in that at least one conduit branches into a plurality of sub-conduits within the nozzle, each sub-conduit being connected to an exit port.

For the discussed reasons of ease of maintenance and cleanliness, a preferred embodiment of the apparatus will seek to avoid moving parts within the nozzle and therefore will preferably comprise a fixed internal geometry. Moreover the nozzle will preferably comprise a reversibly detachable upper and lower section which allows not only disassembly of the nozzle to facilitate cleaning, but also enable simply the lower section of the nozzle to be exchanged for different lower sections, giving different extrusion arrangements.

Nozzles for the purpose of the present invention may be suitably produced by the process of “rapid prototyping” wherein said nozzles are manufactured from a computer-aided-design. Selective laser sintering is an example of a rapid prototyping technique that could be used to produce suitable nozzles wherein nozzles are produced in a layer wise fashion from a laser-fusible powder such as a nylon powder that is dispensed one layer at a time. The powder is fused, or sintered, by the application of laser energy that is directed in a raster scan fashion to those portions of the powder corresponding to a cross-section of the article. After the fusing of powder in each layer an additional layer of powder is then dispensed, and the process repeated, with fused portions of later layers fusing to fused portions of previous layers until the article is complete. Detailed description of selective laser sintering may be found in patents U.S. Pat. No. 4,863,538, U.S. Pat. No. 5,017,753, U.S. Pat. No. 5,076,869 and U.S. Pat. No. 4,944,817, all assigned to Board of Regents, the University of Texas System and in U.S. Pat. No. 4,247,508 assigned to DTM Corporation, Austin, Tex., all incorporated herein by this reference.

Nozzles of the invention preferably comprise a sintered polyamide, preferably the sintered polyamide provides a fine smooth surface finish to provide a food grade material. Suitably polyamide 12 available from DTM Corporation may be used. The sintered article may also be enrobed in any suitable food grade resin such as an epoxy coating. Nozzles may be reproduced by conventional injection moulding of poly-ethylene or other suitable plastic material.

A further particular embodiment of the invention comprises extrusion apparatus for extruding a plurality of ice cream flows, wherein said nozzle comprises two entry ports wherein in a first section of the nozzle one of said entry ports is connected to a conduit which branches into two sub-conduits, each sub-conduit forming a semi-annular chamber around a central conduit, said central conduit being connected to second entry port; subsequently in a second section the central conduit and semi-annular chambers from the first section are connected to a plurality of further sub-conduits, wherein each sub-conduit terminates at an exit port. The aperture of the openings at the exit ports will vary extensively depending on the extrusion shape that is sought.

In a preferred embodiment the exit ports will comprise a symmetrical array of substantially rectangular openings radially arranged about a central point. This configuration of substantially rectangular shaped openings allows a particularly attractive extrusion pattern to be achieved, wherein the inherent property of extruded ice cream flows to buckle and fold at regular intervals is exploited to achieve a layered appearance. The flow of ice cream through each opening is used to generate a plurality of radial segments of substantially superimposed layers in the extrusion product, wherein said radial segments differ in ice cream composition as determined by the entry flow to the nozzle from which they originate.

It is notable and particularly advantageous that the layering appearance in such products of the invention is achieved without any necessity for rotational movement of the nozzle as a whole, any internal component of the nozzle, nor of the receptacle and therefore represent a significant step forward in ice cream extrusion technology.

It is recognised that further refinements could be made to the product appearance by the addition of nuts, candies or flavoured sauces to outer surface of an extruded product. Alternatively in a layered ice cream product a fat based couverture could be introduced between the superimposed layers during the extrusion thereof.

It is a fourth object of the present invention to provide an ice cream product, wherein said product comprises at least three radially adjacent segments and at least two different compositions. In order to provide alternation in composition between adjacent radial segments a product comprising three radial segments will require three different compositions, whereas a product having an even number of radial segments may achieve alternating composition in adjacent segments by having only two different compositions. Preferably the adjacent radial segments of the product of the invention will comprise a plurality of substantially super-imposed layers of ice cream composition, said super-imposed layers may be optionally interleaved with a layer of fat based couverture e.g. caramel or chocolate.

### DETAILED DESCRIPTION

By way of example an embodiment of the invention will be described with reference to the figures wherein;

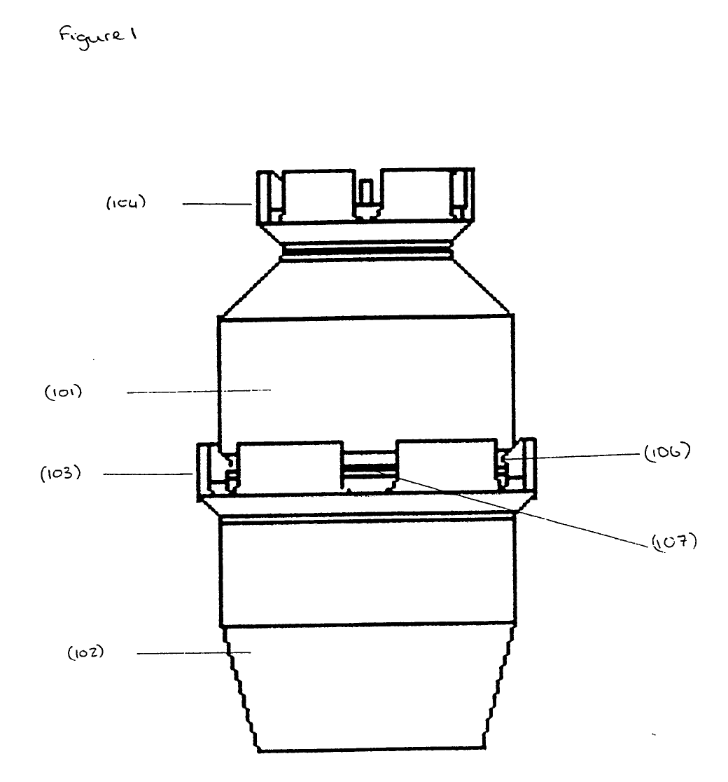

FIG. 1 presents an external side view of a nozzle according to the invention.

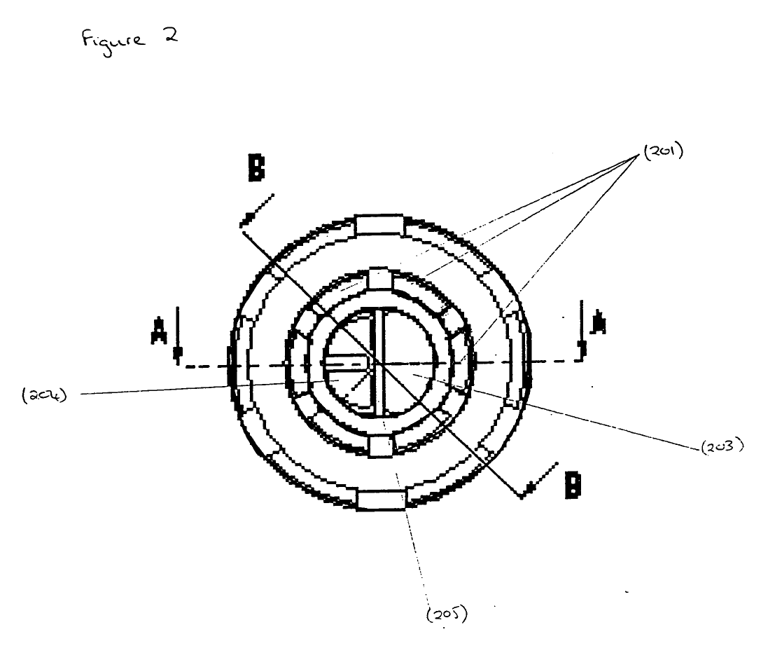

FIG. 2 shows a top view of the apparatus through which ice cream will flow into the nozzle.

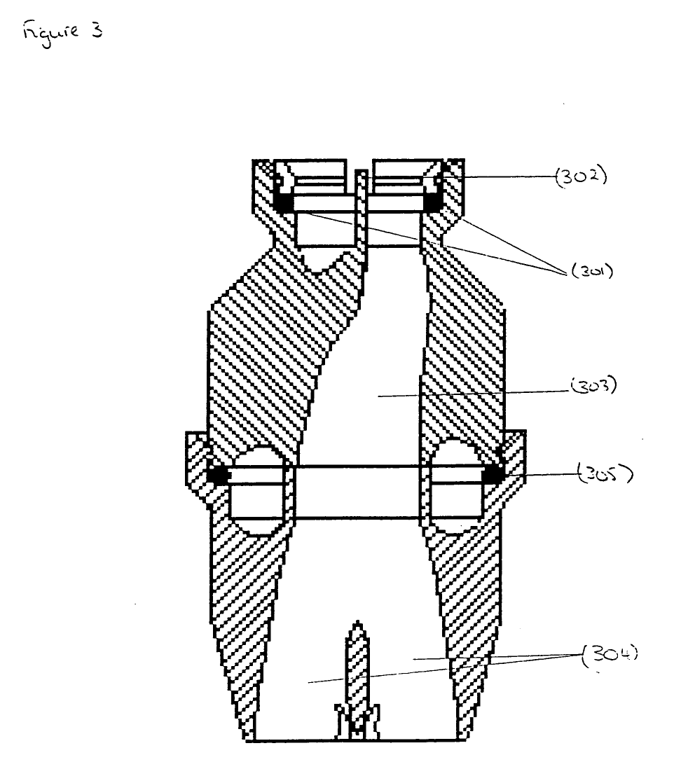

FIG. 3 shows an internal geometry of a nozzle through longitudinal cross-sectional line A-A of FIG. 2, similarly

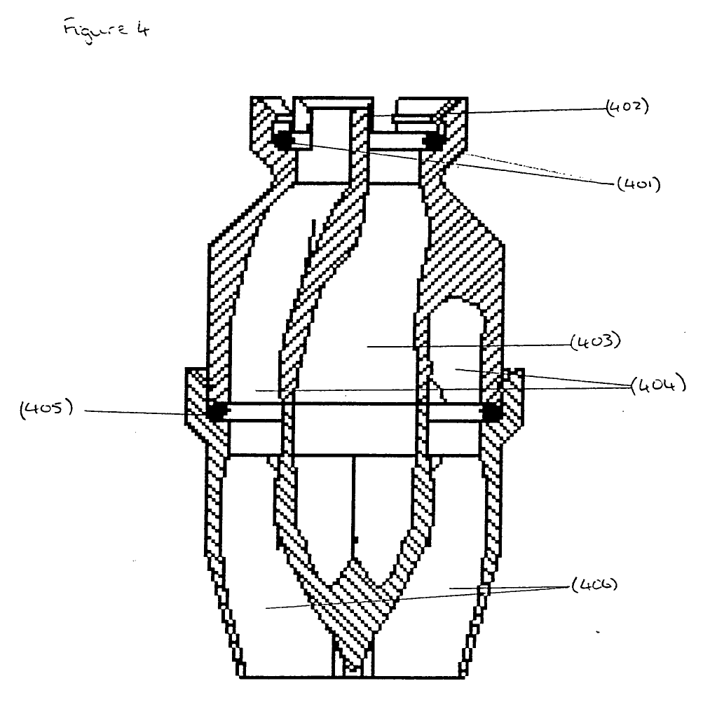

FIG. 4 provides an internal view of the nozzle through a similar cross-sectional line at B-B of FIG. 2.

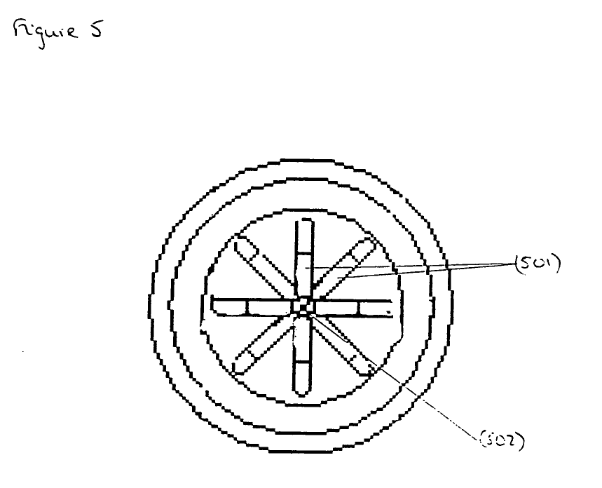

FIG. 5 shows a view of the opening at the base of the nozzle which provides the exit port through which ice cream is extruded.

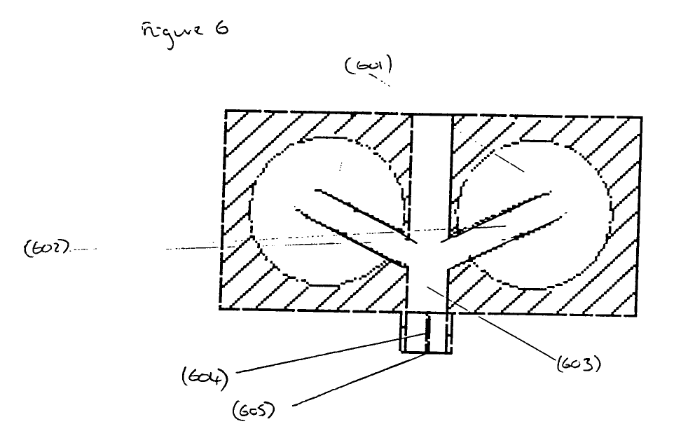

FIG. 6 shows representation of equipment for extrusion of ice cream at point of sale which has been modified for the purpose of the invention.

The nozzle comprises two distinct sections, an first upper section (101) and a lower second section (102), said sections being reversibly attached by a connecting means (103).

The upper section comprises a further connecting means (104) for reversible attachment of the nozzle to a in-flow conduit which will supply the in-flowing ice cream. The attaching means (104) preferably comprises a plurality of arms (201) that are circumferencially arranged around the connecting means (104) so as to complement the geometry at the opening of the in-flow conduit, said arms (201) having sufficient flexibility to allow operation of click system for fastening firmly around said opening of the in-flow conduit. A sealing means (301) (401), such as a rubber ring, is preferably inserted internally at the base of the arms to prevent any ice cream material from escaping when connected to the opening of the in-flow tube.

The nozzle comprises two entry ports (203, 204) separated by the vertical plane (205) reflected in FIGS. 3 and 4 at (302) and (402) respectively.

The entry port (203) is connected in the first section of the nozzle to a single central conduit (303)(403) whereas the conduit connected to the other entry port (204) branches within the nozzle to form two sub-conduits which are geometrically arranged so as to form two semi-annular chambers (404) around the central conduit (403).

The upper and lower sections (101, 102) are reversibly connected by the connecting means (103). This connecting means operates on the same principle as that previously described (104), with the second lower section comprising a plurality of arms that reversibly attach around the outside of the first section to the nozzle in a click connection system (106). A sealing means (107) shown in cross-section in FIG. 3, (305) and FIG. 4, (405) prevents the leakage of ice cream as it flows between the first and second nozzle sections.

In the second section (102) of the nozzle the internal geometry complements and continues the internal conduits established in the first section. Both the central conduit (303) and the two sub-conduits forming the semi-annular chambers (404) branch into a plurality of further sub-conduits (304) and (406) respectively. Each sub-conduit terminates at an exit port forming the array of openings (501) wherein adjacent exit ports are connected to sub-conduits which have branched from different entry ports, thereby allowing the composition of material to be extruded therefrom to originate from a different source.

The connecting means (103) allows a plurality of lower sections with differing internal branching arrangements and thus differing extrusion patterns to be combined therewith. FIG. 5 shows a symmetrical array of substantially rectangular openings (501) radially arranged about a central point (506). Ice cream may be extruded as waves which fold into layered segments wherein adjacent waves alternate in their composition. The aperture of the openings may be varied depending on the thickness of the wave and thus the product appearance that is sought. In a configuration of openings that do not join at the centre a product may be extruded having a central cavity. This cavity can be filled with other ingredients, such as fruits or chocolate.

FIG. 6 shows internal view of apparatus for the co-extrusion of two ice cream compositions at point of sale comprising two ice cream holding means (601) from which flows of different ice cream composition pass through conduits (602) to a central conduit (603). In said central conduit they form a combined flow comprising parallel adjacent ice cream flows which are then separated by the dividing plane (604), along the interface between the ice cream compositions, prior to entry into the nozzle which may be attached therebelow (605) (nozzle not shown).

1. A process for extruding ice cream, said process comprising delivering a plurality of ice cream flows to a nozzle characterised in that, one or more of said ice cream flows are divided into a plurality of additional flows within said nozzle before extrusion of said flows.

2. A process according to claim 1, wherein prior to delivering the plurality of separate ice cream flows to the nozzle, a plurality of separate ice cream flows of one or more compositions and moving in a single flow direction, are combined to a single flow having one or more flow interfaces between said one or more compositions, wherein said combined flow is subsequently divided at said one or more flow interfaces to deliver the plurality of ice cream flows to the nozzle.

3. A process according to claim 1, wherein the nozzle has a fixed internal geometry.

4. A process according to claim 1, wherein the delivery of ice cream flows to a plurality of entry ports in said nozzle is controlled by a valve immediately upstream of the nozzle.

5. A process according to claim 4, wherein the ice cream flows delivered to the entry ports of the nozzle flow from a plurality of holding means.

6. A method of dispensing fresh ice cream at point of sale comprising the steps;
(i) opening a valve to deliver a plurality of ice cream flows to a nozzle;
(ii) filling a containing means with ice cream flowing from the nozzle;
(iii) closing the valve on completion of the filling;
characterised in that, subsequent to step (i) one or more of the ice cream flows are divided into a plurality of additional flows within the nozzle before extrusion.

7. Apparatus for extruding a plurality of ice cream flows in a single flow direction, comprising a nozzle, said nozzle comprising a plurality of entry ports, wherein each entry port is connected to an exit port by way of a conduit running through the nozzle, characterised in that at least one conduit branches into a plurality of sub-conduits within the nozzle, each sub-conduit being connected to an exit port.

8. Apparatus according to claim 7, wherein said nozzle has a fixed internal geometry.

9. Apparatus according to either claim 7, wherein said nozzle comprises two entry ports wherein in a first section of the nozzle one of said entry ports is connected to a conduit which branches into two sub-conduits, each sub-conduit forming a semi-annular chamber around a central conduit, said central conduit being connected to second entry port; subsequently in a second section the central conduit and semi-annular chambers from the first section are connected to a plurality of further sub-conduits, wherein each sub-conduit terminates at an exit port.

10. Apparatus according to claim 9, wherein said exit ports comprise a symmetrical array of substantially rectangular openings radially arranged about a central point.

11. An ice cream product comprising at least three radially adjacent segments and at least two different compositions.

12. An ice cream product according to claim 11, wherein said adjacent radial segments of the product comprise a plurality of substantially super-imposed layers of ice cream composition.
